(19) United States
(12) Patent Application Publication
(10) Pub. No.: US 2005/0244011 A1
(43) Pub. Date: Nov. 3, 2005

(54) Method and apparatus to measure sound quality

(76) Inventor: Jong-bae Kim, Seoul (KR)

Correspondence Address: STANZIONE & KIM, LLP, 919 18TH STREET, N.W., SUITE 440, WASHINGTON, DC, 20006, US

(21) Appl. No.: 11/064,480

(22) Filed: Feb. 24, 2005

(30) Foreign Application Priority Data
Apr. 30, 2004 (KR) 2004-30450

(51) Int. Cl. H04R 29/00

(52) U.S. Cl. 381/56

(57) ABSTRACT

A real-time sound quality evaluating system and method of evaluating sound quality in real-time by using a group of sound quality evaluators as a model. The method includes measuring physical sound quality and sound characteristics generated from an audio system; extracting a plurality of sound quality evaluation factors for each of a plurality of evaluation items on the basis of the measured sound quality and sound characteristics, mapping the extracted sound quality evaluation factors for each evaluation item to scores set on the basis of sound quality evaluation values of the evaluation items obtained by a group of sound quality evaluators, and scoring the evaluation items by adding predetermined weighting factors to the mapped scores of sound quality evaluation candidate factors.

### CROSS-REFERENCE TO RELATED APPLICATIONS

This application claims the priority of Korean Patent Application No. 10-2004-30450, filed on Apr. 30, 2004, in the Korean Intellectual Property Office, the disclosure of which is incorporated herein in its entirety by reference.

### BACKGROUND OF THE INVENTION

1. Field of the Invention

The present general inventive concept relates to a real-time sound quality evaluating system, and more particularly, to a real-time sound quality evaluating system and method of evaluating sound quality in real-time by using sound quality evaluated by a group of people as a model.

2. Description of the Related Art

A skillful sound quality evaluator, i.e., a person who evaluates the quality of sound, performs subjective sound quality evaluation of an audio or AV system on the basis of his or her subjective evaluation of several evaluation items, which is made by listening to familiar sound recordings. The evaluator subjectively evaluates the sound quality of the system by scoring the evaluation results on a sound quality evaluation report. For example, scores such as “1. Tonal Balance: 22, 2. Clarity: 25, 3. Spatial Effect: 17, 4. Ambience: 7, Total score =71” can be marked on the sound quality evaluation report.

However, the evaluation results of this subjective sound quality evaluating method deviate due to the variation of standards among evaluators, uncertainty, and various listening environments affecting sound quality. Therefore, even though the subjective sound quality evaluating method to best represent sound quality that people feel is directly correlated with the sound quality that a sound quality evaluator subjectively feels, problems in accuracy and time constancy exist. Furthermore, if the subjective sound quality evaluating method is used for developing all audio and AV systems, since the audio and AV systems are developed by always performing sound quality evaluation by a group of evaluating people, a great amount of time, efforts, and cost are expended. Accordingly, development efficiency is badly affected.

### SUMMARY OF THE INVENTION

The present general inventive concept provides a real-time sound quality evaluating method and system to evaluate sound quality with respect to a number of evaluation items by extracting a plurality of objective sound quality evaluation factors on the basis of results of subjective sound quality evaluation items evaluated by a number of sound quality evaluators.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a sound quality evaluating method comprising: measuring physical sound quality and sound characteristics generated from an audio system; extracting a plurality of sound quality evaluation factors for each evaluation item on the basis of the measured sound quality and sound characteristics, mapping the extracted sound quality evaluation factors for each evaluation item using scores set on the basis of sound quality evaluation values of the evaluation items obtained by a group of sound quality evaluators, and scoring the evaluation items by adding predetermined weighting factors to the mapped scores of sound quality evaluation candidate factors.

The foregoing and/or other aspects and advantages of the present general inventive concept are also achieved by providing a sound quality evaluating method comprising evaluating and scoring sound quality of each evaluation item of audio and AV systems by a group of sound quality evaluators, measuring physical sound quality and sound characteristics of the audio and AV systems evaluated by the group of sound quality evaluators, extracting a plurality of sound quality evaluation candidate factors on the basis of the measured sound quality and sound characteristics and mapping the extracted sound quality evaluation candidate factors using scores set on the basis of sound quality evaluation values of the evaluation items obtained by the group of sound quality evaluators, selecting factors of the sound quality evaluation items according to a correlation between the mapped scores of the sound quality evaluation candidate factors and scores of the sound quality evaluation items obtained by the group of sound quality evaluators, and scoring the sound quality evaluation items by adding predetermined weighting factors to scores of the selected factors of the sound quality evaluation items.

The foregoing and/or other aspects and advantages of the present general inventive concept are also achieved by providing a sound quality evaluating system comprising a subjective sound quality evaluation calculator to calculate subjective sound quality evaluation values by evaluating a number of audio and AV systems by a group of sound quality evaluators, an objective sound quality evaluation measuring unit to generate objective physical characteristics data of the audio and AV systems, a sound quality evaluation modeling unit to map the data measured by the objective sound quality evaluation measuring unit using the subjective sound quality evaluation values calculated by the subjective sound quality evaluation calculator, and a sound quality evaluation algorithm unit to receive the objective physical sound characteristics data measured by the objective sound quality evaluation measuring unit and to output the sound quality evaluation result scores through modeling of the sound quality evaluation modeling unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a sound quality evaluating system according to an embodiment of the present general inventive concept;

FIG. 2 is an example of a hardware configuration to realize the sound quality evaluating system of FIG. 1;

FIG. 3 is a flowchart of an operation of a sound quality evaluation modeling builder shown in FIG. 1;

FIG. 4 is a flowchart of a subjective sound quality evaluating process performed by a group of sound quality evaluators illustrated in FIG. 3;

FIGS. 5 and 6 are flowcharts illustrating methods of measuring physical sound quality evaluation items described in FIG. 3;

FIGS. 7 through 10 are flowcharts illustrating processes of extracting objective sound quality evaluation factors described in FIG. 3;

FIG. 11 is a graph to analyze a correlation between the scores of sound quality evaluation items evaluated by the group of sound quality evaluators and the scores of measured sound quality evaluation factors described in FIG. 3;

FIG. 12 is a flowchart of an operation of a sound quality evaluation algorithm unit shown in FIG. 1;

FIG. 13 is an example of a graphic user interface (GUI) output by a sound quality evaluation output unit shown in FIG. 1; and

FIG. 14 is a flowchart of a process of diagnosing sound quality evaluation scores using result values evaluated by a sound quality evaluation algorithm unit shown in FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

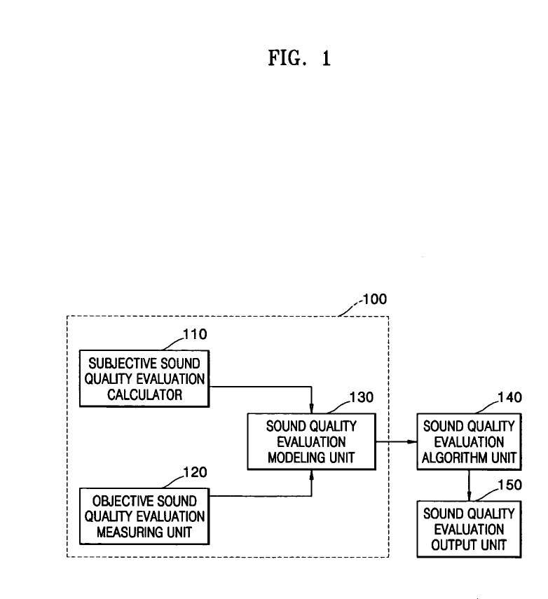

FIG. 1 is a block diagram of a sound quality evaluating system according to an embodiment of the present general inventive concept.

Referring to FIG. 1, the sound quality evaluating system includes a sound quality evaluation modeling builder 100, a sound quality evaluation algorithm unit 140, and a sound quality evaluation output unit 150. The sound quality evaluation modeling builder 100 includes a subjective sound quality evaluation calculator 110, an objective sound quality evaluation measuring unit 120, and a sound quality evaluation modeling unit 130.

The subjective sound quality evaluation calculator 110 calculates subjective sound quality evaluation values by evaluating a number of audio and AV systems by a group of sound quality evaluators.

The objective sound quality evaluation measuring unit 120 measures physical sound characteristics from the audio and AV systems to be evaluated and converts the physical sound characteristics to sound quality evaluation candidate factors.

The sound quality evaluation modeling unit 130 maps the sound quality evaluation candidate factors measured by the objective sound quality evaluation measuring unit 120 using the subjective sound quality evaluation values calculated by the subjective sound quality evaluation calculator 110. Here, the sound quality evaluation modeling unit 130 approximates the objective sound quality evaluation candidate factors so that the objective sound quality evaluation candidate factors have a same score range as a score range of the subjective sound quality evaluation values. This type of score range of the subjective sound quality evaluation values creates a subjective sound quality evaluation format.

The sound quality evaluation algorithm unit 140 receives the sound quality evaluation candidate factors measured by the objective sound quality evaluation measuring unit 120 and generates a sound quality evaluation result using the subjective sound quality evaluation format through modeling of the sound quality evaluation modeling unit 130. Also, the sound quality evaluation algorithm unit 140 generates a diagnosis result message of the sound quality evaluation values by adding an additional sound quality evaluation diagnosis function to a sound quality evaluation function.

The sound quality evaluation output unit 150 outputs the sound quality evaluation result and the diagnosis result evaluated by the sound quality evaluation algorithm unit 140 on a screen in the form of a graphic user interface (GUI).

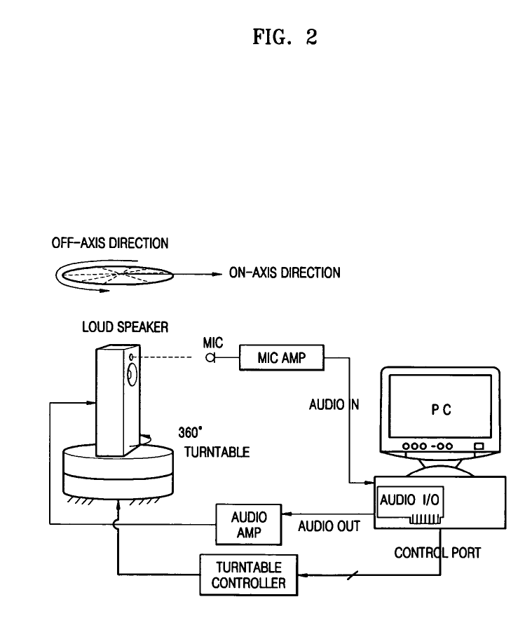

FIG. 2 is an example of a hardware configuration to realize the sound quality evaluating system of FIG. 1.

Referring to FIG. 2, a loudspeaker is measured for sound quality evaluation. A microphone (MIC) converts sound pressure reproduced by the loudspeaker to an electrical signal. A microphone amplifier (MIC AMP) amplifies the electrical signal converted by the MIC to a predetermined level. An audio input/output interface (AUDIO I/O) is installed in a personal computer (PC), receives the audio signal amplified by the MIC AMP, and outputs a sound source. A turntable controller rotates a turntable, which is used when measuring an impulse response function in an off-axis direction, by a predetermined angle. A PC program (not shown) is launched in the PC, controls audio inputs/outputs and the turntable, and performs a sound quality evaluation simulation in real-time.

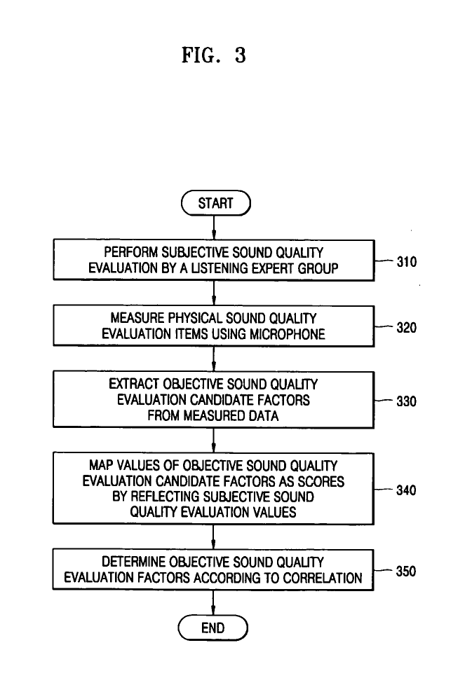

FIG. 3 is a flowchart of an operation of the sound quality evaluation modeling builder 100 shown in FIG. 1.

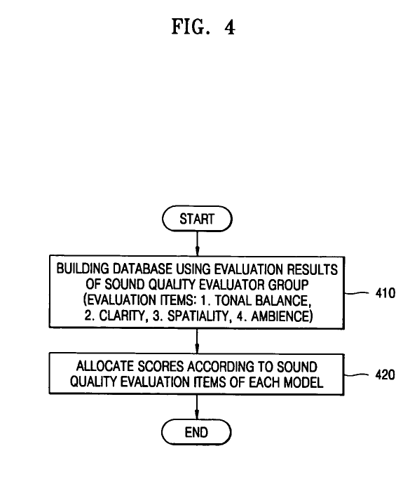

First, a process of mapping physically measurable sound quality evaluation factors using listening results of an expert group of evaluators, who can determine relatively exact scores by listening to the sound, is required. Therefore, a sound quality evaluation group is set up, and subjective sound quality evaluation of audio and AV systems is performed by the sound quality evaluation group in operation 310. That is, as shown in FIG. 4, the sound quality evaluation group evaluates a number of audio and AV systems based on predetermined sound quality evaluation items and builds a database using the evaluation results in operation 410. For example, “tonal balance,” “clarity,” “spatial,” and “ambience” are defined as the sound quality evaluation items. Scores according to the sound quality evaluation items are allocated to each system model and averaged in operation 420. That is, the scores according to the sound quality evaluation items are used to determine a scoring range and power of discrimination when the subjective sound quality evaluation is performed.

Physical sound characteristics of the audio and AV systems evaluated by the sound quality evaluation group are measured using a microphone in operation 320. Here, to obtain characteristics of a loudspeaker, the measurement is performed in a perfectly echo-free room. The measured items are as follows.

1. Impulse response functions of a loudspeaker when different sound pressure conditions are applied to the loudspeaker.

1) In a case of using a stereo: response functions of a left speaker and a right speaker are measured.

2) In a case of using 2.1 channels: response functions of a left speaker, a right speaker, a subwoofer, and the left and right speakers combined with the subwoofer are measured.

3) In a case of using 5.1 channels: response functions of each satellite speaker, a subwoofer, and the satellite speakers combined with the subwoofer are measured.

2. Impulse response functions of an off-axis loudspeaker.

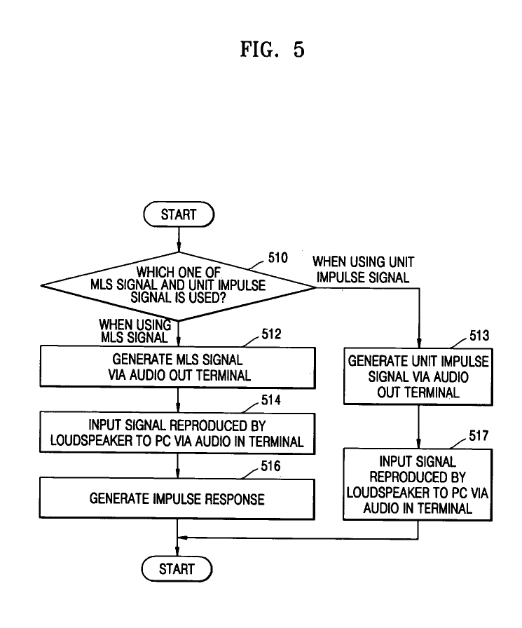

Referring to FIGS. 2 and 5, an embodiment of the present general inventive concept in which an impulse response function is measured in an on-axis direction will now be described. It is determined which one of a maximum length sequences (MLS) signal and a unit impulse response signal is used as an audible band signal in operation 510. If it is determined that the MLS signal is used as the audible band signal in operation 510, the MLS signal is output via an AUDIO OUT terminal in operation 512, the MLS signal reproduced from the loudspeaker is input to the PC via an AUDIO IN terminal in operation 514, and the input MLS signal is generated as an impulse response signal in operation 516. On the other hand, if it is determined that the unit impulse response signal is used as the audible band signal in operation 510, the unit impulse response signal is output via the AUDIO OUT terminal in operation 513, and the signal reproduced from the loudspeaker is input to the PC via the AUDIO IN terminal in operation 517.

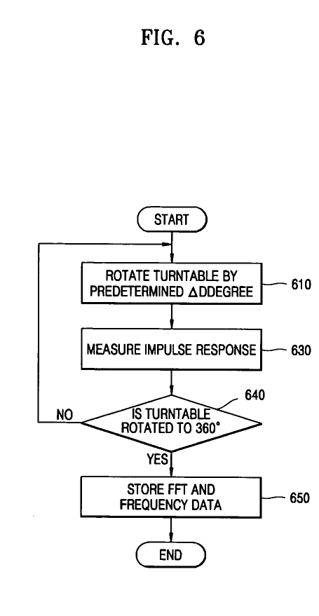

Referring to FIGS. 2 and 6, an embodiment of the present general inventive concept in which an impulse response function is measured in an off-axis direction will now be described. A turntable is rotated to a predetermined angle in operation 610, and an impulse response function of an audio signal generated from the loudspeaker is measured in operation 630. When the turntable is rotated to 360° in operation 640, fast Fourier transform (FFT) and frequency data is extracted by performing a windowing process in operation 650.

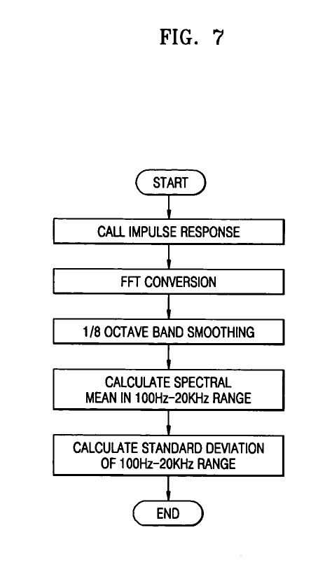

The measured physical sound characteristics data is converted to a plurality of sound quality evaluation candidate factors on the basis of a signal processing theory in operation 330. A method of measuring physical sound quality evaluation factors will now be described with reference to FIGS. 7 through 10.

1. Calculate spectral deviation (refer to FIG. 7).

An impulse response is obtained and FFT converted. The FFT converted impulse response is smoothed using a ⅛-octave band. A spectral mean is calculated from the impulse response in a 100 Hz-20 KHz range. A standard deviation is calculated from the impulse response in the 100 Hz-20 KHz range.

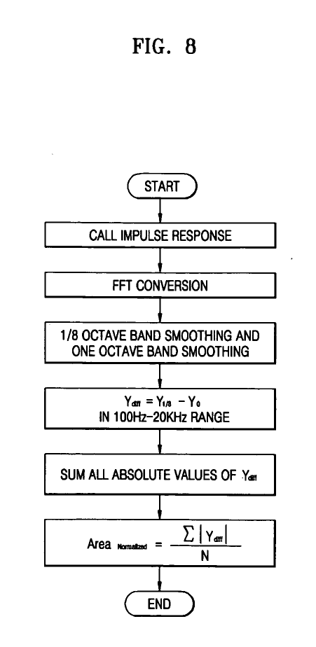

2. Calculate normalized area of peak/dip (refer to FIG. 8).

An impulse response is obtained and FFT converted. The FFT converted impulse response is smoothed using a ⅛-octave band and a 1-octave band. Differences Y_{diff}=Y_{1/8}−Y₁ are calculated from the impulse response in a 100 Hz-20 KHz range. All absolute values of Y_{diff} are summed up. The area of peak/dip can be represented as

$${Area}_{Normalized} = \frac{\sum \vert {Y}_{diff} \vert}{N}$$

where N indicates the number of bands.

3. Calculate bass level, midrange level, and treble level.

An impulse response is ⅛-octave scaled, and bass, midrange, and treble levels are calculated.

4. Calculate difference between a cross frequency level and a mean level.

5. Calculate midrange deviation.

A midrange deviation that is an index indicating frequency smoothness in a midrange (400 Hz-6 KHz) is calculated.

6. Calculate difference between a high treble level and a treble level.

A difference between a mean of a high treble range and a mean of a treble range is calculated.

7. Calculate amount of level change per frequency band according to volume.

8. Calculate amount of time decay of bass, midrange, and treble ranges.

9. Calculate damping level of a frequency response function of each of bass, midrange, and treble ranges.

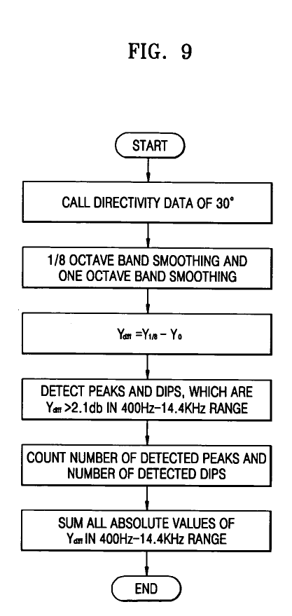

10. Calculate the number of dips, which are more than −3 dB as compared with 0° on a frequency characteristic in a 30° off-axis (refer to FIG. 9).

Thirty degrees directivity data is obtained. The directivity data is smoothed using a ⅛-octave band and a 1-octave band. Differences Y_{diff}=Y_{1/8}−Y₁ are calculated. Peaks and dips where Y_{diff} is larger than 2.1 dB in a 400 Hz-14.4 KHz range are detected. The number of detected peaks and the number of detected dips are counted. All absolute values of Y_{diff} in the 400 Hz-14.4 KHz range are added.

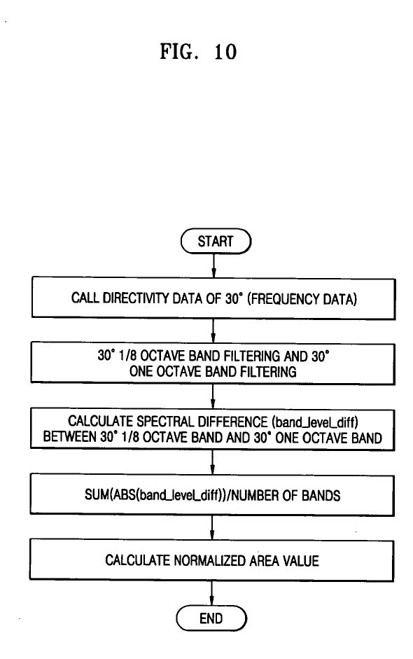

11. Calculate damping level as compared with a frequency response function in a 30° angle (refer to FIG. 10).

Thirty degrees directivity data is obtained. The directivity data is filtered into a 30° ⅛-octave band and a 30° 1-octave band. Spectral differences (band_level_diff) between the 30° ⅛-octave band and the 30° 1-octave band are obtained. SUM(ABS(band_level_diff))/the number of bands is calculated. A normalized area value is obtained.

The measured sound quality evaluation candidate factors are mapped to scores of objective sound quality set on the basis of the sound quality evaluation values of items obtained by the evaluator group in operation 340.

A look-up table can be used as a method of mapping scores of the sound quality evaluation candidate factors. Also, a polynominal function, an exponential function or a logarithm function may be used as the method of mapping scores of the sound quality evaluation candidate factors. Here, scores of the objective sound quality approximated to have the same scale as the sound quality evaluation scores of items obtained by the evaluator group with respect to the sound quality evaluation factors of items, are mapped in the look-up table.

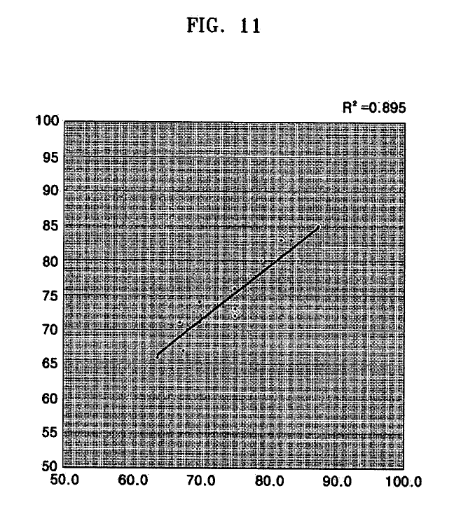

The sound quality evaluation candidate factors related to four sound quality evaluation items are selected by analyzing a correlation between scores of the objective sound quality evaluation factors set in the look-up table and scores of sound quality evaluation items evaluated by the group of sound quality evaluators in operation 350. That is, objective sound quality evaluation factors having a high correlation with respect to four main subjective sound quality evaluation items, for example: 1. Tonal balance; 2. Clarity; 3. Spatial; and 4. Ambience, are obtained by analyzing a correlation between scores of the objective sound quality evaluation factors extracted by a measuring system and scores of the sound quality evaluation items evaluated by the group of sound quality evaluators. FIG. 11 is an example of the correlation analysis. Here, the x-axis indicates scores of measured sound quality evaluation factors, and the y-axis indicates scores of sound quality evaluation items evaluated by the group of sound quality evaluators. For example, if sound quality evaluation results evaluated by a subjective evaluator group is highly correlated with scores of objective sound quality evaluation factors, the correlation becomes “1” as shown in FIG. 11, and if the sound quality evaluation results evaluated by the subjective evaluator group is rarely correlated with the scores of the objective sound quality evaluation factors, the correlation becomes “0”. The objective sound quality evaluation factors having a high correlation for each evaluation item by each correlation analysis are as follows.

1. Tonal balance

1) Spectral deviation.

2) Normalized area of peak/dip.

3) Bass level, mid level, and treble level.

4) Difference between a crossover frequency level and a mean level.

5) Midrange spectral deviation.

6) Difference between a high treble level and a treble level.

7) The amount of level change per frequency band according to volume.

2. Clarity

1) The amount of time decay of each of bass, mid, and treble ranges.

2) Damping level of a frequency response function of each of bass, mid, and treble ranges.

3. Spatiality

1) The number of dips, which are lower than −3 dB comparing to 0° based on a frequency characteristic in a 30° off-axis.

2) Damping level as compared with a frequency response function in a 30° angle.

4. Ambience

1) Bass level as compared with other bands.

2) Damping level as compared with a response function of bass and mid ranges.

3) Damping level as compared with a frequency response function in a 30° angle.

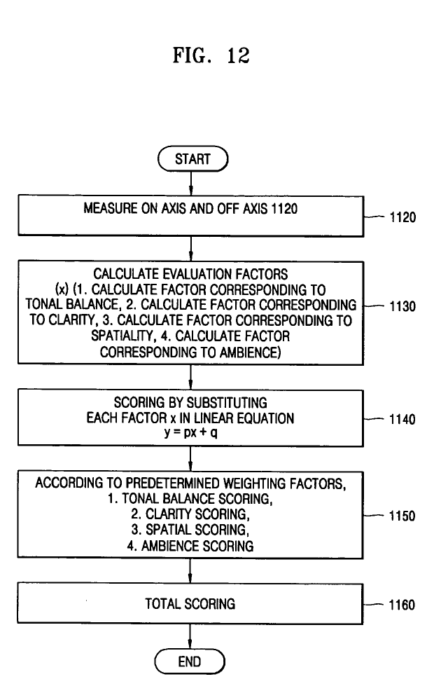

FIG. 12 is a flowchart of an operation of the sound quality evaluation algorithm unit 140 shown in FIG. 1.

The sound quality evaluation algorithm unit 140 performs a sound quality evaluation simulation in real-time after a subjective sound quality evaluation model is built.

Physical sound quality and sound characteristics generated by an audio system or an AV system are measured in on-axis and off-axis directions in operation 1120.

A plurality of sound quality evaluation factors (x) are calculated for each item using the measured sound quality and sound characteristics in operation 1130. For example, factors corresponding to 1. Tonal balance, 2. Clarity, 3. Spatial, and 4. Ambience are calculated using a signal processing algorithm.

The calculated sound quality evaluation factors (x) for each item are mapped to scores (y) using a look-up table set on the basis of sound quality evaluation values for each item obtained by a sound quality evaluation group in operation 1140. Here, the objective sound quality evaluation factors are expressed with the same score format as results evaluated by the subjective sound quality evaluation group.

The items are scored by adding predetermined weighting factors to the scores of the sound quality evaluation candidate factors in operation 1150. Here, the weighting factors subjectively affect scoring of sound quality and are adjusted according to a sound quality standard of a style that a user desires. For example, a tonal balance score can be evaluated as follows:

{T₁σ_{Full}+T₂A_{Full-pd}+T₃d_{LowFreq.}+T₄L_{Bass}+T₅L_{Mid}+T₆L_{Treble}+T₇σ_{Mid}+T₈d_{HighTreble}+T₉d_{SatSubCrossover}} where T₁˜T₉=Tonal balance weighting factors, σ_{Full}=Full range spectral deviation, A_{Full-pd}=Normalized area of peaks/dips, L_{Bass}=Bass level, L_{Mid}=Midrange level, L_{Treble}=Treble level, σ_{Mid}=Midrange deviation, d_{HighTreble}=Difference between a high treble level and a treble level, d_{SatSubCrossover}=Satellite and subwoofer crossover difference.

Finally, scores of items are added in operation 1160.

That is, when sound quality evaluation is performed in real-time, the scores of items obtained by adding weighting factors to the scores of sound quality evaluation candidate factors and a total score obtained by adding the scores of all the items together are represented in a graphic form. Here, in another embodiment, a diagnosis result of sound quality evaluation is represented by comparing the total score obtained by adding the scores of sound quality evaluation items to predetermined standard values. For example, if the comparison result is “80≦total score≦100”, “good sound quality” is displayed on the screen, if the comparison result is “70≦total score≦80”, “normal sound quality” is displayed on the screen, and if the comparison result is “total score≦70”, “bad sound quality” is displayed on the screen.

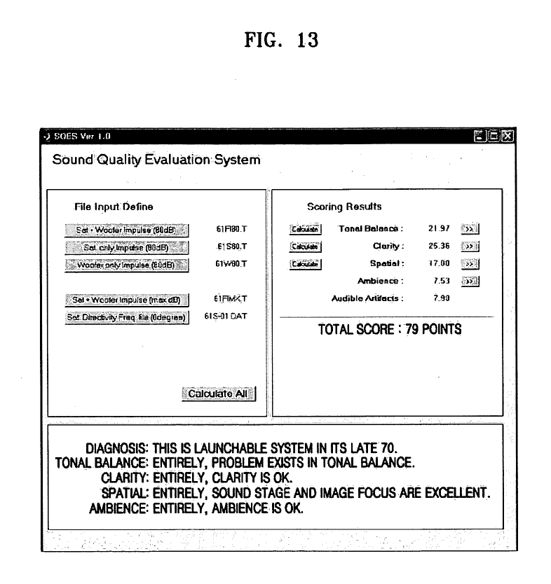

FIG. 13 is an example of a graphic user interface (GUI) output by the sound quality evaluation output unit 150 shown in FIG. 1.

Referring to FIG. 13, input impulse response items to be measured, sound quality evaluation results evaluated by the sound quality evaluation algorithm unit 140, and diagnosis results are displayed on a screen using a GUI. For example, the GUI generates a graphical menu to calculate measured physical sound characteristic values, scores of items, a total score, and diagnosis results of the scores.

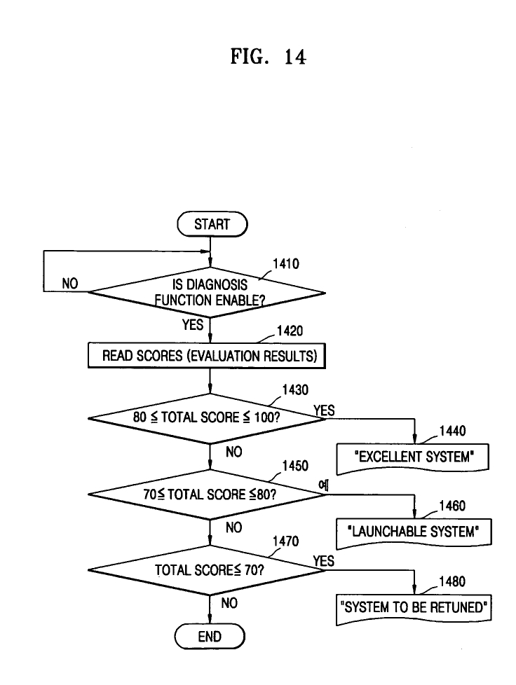

FIG. 14 is a flowchart of a process of diagnosing sound quality evaluation scores using result values evaluated by the sound quality evaluation algorithm unit 140 shown in FIG. 1.

It is checked whether a diagnosis function of sound quality evaluation scores is enabled in operation 1410. If the diagnosis function is enabled, sound quality evaluation results (scores of items and a total score) are read in operation 1420. A diagnosis result of all items and diagnosis results of individual items are generated by comparing predetermined standard values with the read scores of items and a total score in operations 1430 through 1480. For example, graphic data is generated such as “excellent system” when 80≦total score≦100, “launchable system” when 70≦total score≦80, or “system to be retuned” when total score≦70.

The general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to embodiments of the present general inventive concept, sound quality evaluation as well as subjective sound quality evaluation can be directly performed in any places by measuring sound quality of audio and AV systems to be evaluated in an echo-free room using a sound quality evaluation system embodied by the present general inventive concept, and the sound quality evaluation can be displayed as scores as well as the subjective sound quality evaluation. Also, development time and development cost can be reduced by omitting a process of composing a new group of sound quality evaluators for every system development and allowing the group of sound quality evaluators to score every developed system. Moreover, since deviation of evaluation results due to the configuration and tastes of the evaluation of a group of sound quality evaluators and variations in a listening environment can be removed, reliability of the sound quality evaluation can increase.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A sound quality evaluating method comprising:
measuring physical sound characteristics generated by an audio system;
extracting a plurality of sound quality evaluation factors for each of a plurality of evaluation items on the basis of the measured sound characteristics;
mapping the extracted sound quality evaluation factors for each evaluation item to scores set on the basis of sound quality evaluation values of the evaluation items obtained by a group of sound quality evaluators; and
scoring the evaluation items by adding predetermined weighting factors to the mapped scores of sound quality evaluation factors.

2. The method of claim 1, wherein the mapping of the extracted sound quality evaluation factors comprises:
mapping sound quality evaluation factors for each evaluation item as scores approximated to have the same scale as sound quality evaluation scores of the evaluation items obtained by the group of sound quality evaluators.

3. The method of claim 1, wherein the mapping of the extracted sound quality evaluation factors comprises:
if values of the sound quality evaluation factors are input, outputting scores corresponding to the values with reference to a look-up table.

4. A sound quality evaluating method comprising:
calculating subjective sound quality evaluation scores by evaluating sound quality of each evaluation item of audio and AV systems by a group of sound quality evaluators;
measuring physical sound characteristics of the audio and AV systems corresponding to the evaluation objects of the group of sound quality evaluators and extracting a plurality of sound quality evaluation candidate factors on the basis of the measured sound characteristics;
forming sound quality evaluation models by matching the extracted sound quality evaluation candidate factors to the calculated subjective sound quality evaluation scores; and
outputting objective sound quality evaluation scores having the same scale as the subjective sound quality evaluation scores by performing the sound quality evaluation modeling of the extracted sound quality evaluation candidate factors.

5. The method of claim 4, wherein the calculating of the subjective sound quality evaluation scores comprises:
evaluating a number of audio and AV systems by predetermined sound quality evaluation items; and
averaging scores of the sound quality evaluation items by allocating the scores of the sound quality evaluation items according to the models.

6. The method of claim 4, wherein the forming of the sound quality evaluation models comprises:
mapping the extracted sound quality evaluation candidate factors using scores set on the basis of sound quality evaluation values of the evaluation items obtained by a group of sound quality evaluators;
selecting factors of the sound quality evaluation items according to a correlation between the mapped scores of the sound quality evaluation candidate factors and scores of the sound quality evaluation items obtained by the group of sound quality evaluators; and
adding predetermined weighting factors to scores of the selected factors of the sound quality evaluation items.

7. The method of claim 6, wherein the mapping of the extracted sound quality evaluation candidate factors comprises:
mapping sound quality evaluation factors for each evaluation item as scores approximated to have the same scale as sound quality evaluation scores of the evaluation items obtained by the group of sound quality evaluators.

8. The method of claim 4, wherein the weighting factors are adjusted according to a sound quality standard.

9. A sound quality evaluation diagnosing method comprising:
measuring physical sound characteristics generated from an audio system;
extracting a plurality of sound quality evaluation factors for each of a plurality of evaluation items on the basis of the measured sound characteristics;
mapping the extracted sound quality evaluation factors for each evaluation item to scores set on the basis of sound quality evaluation values of the evaluation items obtained by a group of sound quality evaluators;
calculating scores of the evaluation items by adding predetermined weighting factors to the mapped scores of sound quality evaluation factors and summing the scores of the evaluation items; and
outputting results diagnosed by comparing the summed score and predetermined standard values.

10. A sound quality evaluating system comprising:
a subjective sound quality evaluation calculator to calculate subjective sound quality evaluation values of a number of audio and AV systems evaluated by a group of sound quality evaluators;
an objective sound quality evaluation measuring unit to generate objective physical sound characteristics data of the audio and AV systems;
a sound quality evaluation modeling unit to map the data measured by the objective sound quality evaluation measuring unit using the subjective sound quality evaluation values calculated by the subjective sound quality evaluation calculator; and
a sound quality evaluation algorithm unit to receive the objective physical sound characteristics data measured by the objective sound quality evaluation measuring unit and to output sound quality evaluation result scores through modeling of the sound quality evaluation modeling unit.

11. The system of claim 10, wherein the objective sound quality evaluation measuring unit comprises:
a microphone to convert sound pressure reproduced by a loudspeaker to an electrical signal;
an audio input/output interface to input the electrical signal converted by the microphone;
a turntable to rotate the loudspeaker by a predetermined angle;
a controller to control rotation of the turntable; and
a programming unit to extract physical sound characteristics data of the signal input via the audio input/output interface.

12. The system of claim 10, wherein the sound quality evaluation modeling unit receives the objective physical sound characteristics data and approximates scores of the objective physical sound characteristics data to have the same scoring range as the subjective sound quality evaluation values.

13. The system of claim 10, wherein the sound quality evaluation algorithm unit receives the measured objective physical sound characteristics data and generates scores of the subjective sound quality evaluation format by performing the sound quality evaluation modeling of the measured objective physical sound characteristics data.

14. The system of claim 10, further comprising:
a sound quality evaluation output unit outputting the sound quality evaluation result scores evaluated by the sound quality evaluation algorithm unit on a screen using a graphic user interface (GUI).

15. A method of evaluating sound quality, comprising:
obtaining subjective sound quality evaluation values by evaluating a number of audio and AV systems;
measuring physical sound characteristics from the audio and AV systems to be evaluated and converting the physical sound characteristics to sound quality evaluation candidate factors;
mapping the sound quality evaluation candidate factors using the subjective sound quality evaluation values obtained such that the sound quality evaluation candidate factors have a same score range as a score range of the subjective sound quality evaluation values; and
generating a sound quality evaluation result using the subjective sound quality evaluation scores.

16. The method of claim 15, further comprising:
generating a diagnosis result message of sound quality evaluation values by adding an additional sound quality evaluation diagnosis function to a sound quality evaluation function.

17. The method of claim 16, further comprising:
outputting the sound quality evaluation result and the diagnosis result on a screen in the form of a graphic user interface (GUI).

18. The method of claim 15, wherein the mapping scores of the sound quality evaluation candidate factors is performed by using a look-up table, such that scores of the objective sound quality are mapped into the look-up table.

19. The method of claim 15, wherein the mapping scores of the sound quality evaluation candidate factors is performed by using a polynomial function, an exponential function or a logarithm function.

20. The method of claim 15, wherein the evaluating of a number of audio and AV systems is based on predetermined quality evaluation items.

21. The method of claim 20, wherein the sound quality evaluation items include tonal balance, clarity, spatial and ambience.

22. A computer readable storage medium containing codes to perform a method of evaluating sound quality, the method comprising:
measuring physical sound characteristics generated by an audio system;
extracting a plurality of sound quality evaluation factors for each of a plurality of evaluation items on the basis of the measured sound characteristics;
mapping the extracted sound quality evaluation factors for each evaluation item to scores set on the basis of sound quality evaluation values of the evaluation items obtained by a group of sound quality evaluators; and
scoring the evaluation items by adding predetermined weighting factors to the mapped scores of sound quality evaluation factors.

23. The computer readable storage medium of claim 22, wherein the operation of mapping the extracted sound quality evaluation factors comprises:
mapping sound quality evaluation factors for each evaluation item as scores approximated to have the same scale as sound quality evaluation scores of the evaluation items obtained by the group of sound quality evaluators.

24. The computer readable storage medium of claim 22, wherein the mapping of the extracted sound quality evaluation factors comprises:
if values of the sound quality evaluation factors are input, outputting scores corresponding to the values with reference to a look-up table.

25. A computer readable storage medium containing codes to perform a method of evaluating sound quality, the method comprising:
calculating subjective sound quality evaluation scores by evaluating sound quality of each evaluation item of audio and AV systems by a group of sound quality evaluators;
measuring physical sound characteristics of the audio and AV systems corresponding to the evaluation objects of the group of sound quality evaluators and extracting a plurality of sound quality evaluation candidate factors on the basis of the measured sound characteristics;
forming sound quality evaluation models by matching the extracted sound quality evaluation candidate factors to the calculated subjective sound quality evaluation scores; and
outputting objective sound quality evaluation scores having the same scale as the subjective sound quality evaluation scores by performing the sound quality evaluation modeling of the extracted sound quality evaluation candidate factors.

26. The computer readable storage medium of claim 25, wherein the calculating of the subjective sound quality evaluation scores comprises:
evaluating a number of audio and AV systems by predetermined sound quality evaluation items; and
averaging scores of the sound quality evaluation items by allocating the scores of the sound quality evaluation items according to the models.

27. The computer readable storage medium of claim 25, wherein the forming of the sound quality evaluation models comprises:
mapping the extracted sound quality evaluation candidate factors using scores set on the basis of sound quality evaluation values of the evaluation items obtained by a group of sound quality evaluators;
selecting factors of the sound quality evaluation items according to a correlation between the mapped scores of the sound quality evaluation candidate factors and scores of the sound quality evaluation items obtained by the group of sound quality evaluators; and
adding predetermined weighting factors to scores of the selected factors of the sound quality evaluation items.

28. The computer readable storage medium of claim 27, wherein the mapping of the extracted sound quality evaluation candidate factors comprises:
mapping sound quality evaluation factors for each evaluation item as scores approximated to have the same scale as sound quality evaluation scores of the evaluation items obtained by the group of sound quality evaluators.

29. The computer readable storage medium of claim 25, wherein the weighting factors are adjusted according to a sound quality standard.

30. A computer readable storage medium containing codes to perform a method of evaluating sound quality, the method comprising:
measuring physical sound characteristics generated from an audio system;
extracting a plurality of sound quality evaluation factors for each of a plurality of evaluation items on the basis of the measured sound characteristics;
mapping the extracted sound quality evaluation factors for each evaluation item to scores set on the basis of sound quality evaluation values of the evaluation items obtained by a group of sound quality evaluators;
calculating scores of the evaluation items by adding predetermined weighting factors to the mapped scores of sound quality evaluation factors and summing the scores of the evaluation items; and
outputting results diagnosed by comparing the summed score and predetermined standard values.
